(19) United States
(12) Patent Application Publication
(10) Pub. No.: US 2008/0015890 A1
(43) Pub. Date: Jan. 17, 2008

(54) METHOD AND APPARATUS FOR SEARCHING FOR REAL PROPERTY

(76) Inventor: Krishna Malyala, Piscataway, NJ (US)

Correspondence Address: Mr. Walter J. Tencza Jr., Suite 3, 10 Station Place, Metuchen, NJ, 08840, US

(21) Appl. No.: 11/863,706

(22) Filed: Sep. 28, 2007

(51) Int. Cl. G06Q 10/00; G06Q 30/00

(52) U.S. Cl. 705/1

(57) ABSTRACT

A method is provided including entering a user monthly affordable range for a user into an interactive device, searching on the internet through information concerning a plurality of required monthly cost amounts for a corresponding plurality of real properties, and displaying information concerning one or more real properties of the plurality of real properties. Each of the one or more displayed real properties may have a corresponding required monthly cost amount which is less than or approximately equal to the user monthly affordable amount.

### FIELD OF THE INVENTION

This invention relates to improved methods and apparatus concerning the field of real estate.

### BACKGROUND OF THE INVENTION

In today's home buying market, the home buyer is often given limited information, or information that doesn't hold up in the long term. When an individual starts looking at houses, the individual is typically given a raw price of a home or the list price, but a raw price is not enough information to help the individual make the right choices. People get one shock after another when buying a home, such as actual interest rate, mortgage insurance rates, second mortgage costs, and insurance.

First of all, the list/raw price of the home by itself, doesn't tell an individual what his or her monthly mortgage costs are going to be, which is what people really base their decision on buying a home on. A real estate agent or a mortgage broker can give estimates, but those estimates are often based on assumed factors and only on the homes that the user is interested in. Only as the process moves forward does the home buyer learn things like (1) the actual interest rate on a mortgage payment, (2) mortgage insurance and (3) second mortgage costs, if any, which will be based on the buyer's credit score and what the buyers put down. By the time these things are revealed, the home buyer has already invested a lot of time in looking at a particular home and perhaps has become emotionally invested in a particular property.

The base or first mortgage payment is just the start of an individual's housing costs of owning a home or investment property. On average another forty to forty-five percent should be added on to get a more realistic idea of total monthly costs of owning a property. So if an individual's mortgage payment is $1,079, the true total cost is about $1,519 per month. Financial expert Suzie Orman, in an article titled “The True Cost of Home Ownership” for Yahoo! Finance (trademarked) states that things like property tax, homeowner's insurance, private mortgage insurance, and maintenance costs add up to about forty to forty-five percent on top of the monthly mortgage payment.

Further additional costs to home ownership may include but are not limited to property taxes, condo/co-op and association fees, commuting costs, lawn maintenance, utility costs (electric, gas, and other), and general upkeep. Further information which may be relevant to the cost of home ownership is tax breaks. A lot of these costs don't become clear until perhaps after the deal is done and the buyer/investor has moved into the property. These factors can add up to a financial commitment that the home buyer might not have made had he or she been faced with them at the beginning of the buying process. These extra costs can add another quarter to a third onto monthly mortgage payments. What people find is that the mortgage is only half the story when it comes to figuring out whether you can afford a particular home at a particular price

There are some tools available to help potential home buyers gather more information. There are mortgage calculators online, such as one run by the Motley Fool (trademarked) and Realtor.com (trademarked). A sample prior art mortgage calculator is shown in FIG. 2. The home buyer can get his or her credit score from Myfico.com (trademarked) or from the credit agencies and plug it into the Motley Fool's (trademarked) mortgage calculator or a similar tool to get a better idea of what's going on. But interest rates change daily and they are different for different home buyers. A one percent difference in the interest rate can make a huge difference in calculating monthly expenses. Typically, the prior art way to search for homes is by price and/or geographic area. (FIG. 1 prior art) Typically, prior art searches for buying a home are based on minimum (14a) and maximum (16a) price. There are more options to search but that does not relate to what an individual's monthly payment will be for a home. The prior art searches are based primarily on price centric considerations rather than on what the monthly payments will be for a house. FIG. 2 shows a mortgage calculator. Some prior art like Realtor.com (trademarked) have integrated sample mortgage payments but an individual cannot search based on this information. Other prior art also provide mortgage calculators on each home but still can't search on this factor.

### SUMMARY OF THE INVENTION

One or more embodiments of the present invention provide a method of searching for real estate that is typically user centric as opposed to price centric. In one embodiment a computer data base search and/or internet search is conducted based on information entered by an end user. Typically, the search is not just based on price of a house, but on monthly payment of various expenses.

In one embodiment of the present invention, the search criteria may be applied to many or all the homes in the computer database, or in a geographic area, and not just to one home or property. A computer program or computer application running on a computer processor may precalculate total life style costs for each user. Each output may be different for each user, because each user may work at a different location, drive a different car, and there may be different down payments, different interest rates, and different taxes on each home, etc.

One or more embodiments of the present invention relate to searching by monthly payment for a house. Other factors such as tolls, parking, driving time, cost of gas, taxes, heating and cooling of a home, trains and/or bus cost, and fees and any other fees associated with that home, may also be taken into account.

All the above information is gathered as feeds from a data source into a central computer storage, or data base. For example, the computer software and/or computer processor may get tax information from local or county government or aggregators to get the latest tax information. The computer processor may also get time and fares information from public transportation web sites or other sources in the public domain to figure out commuting costs and timing. End users can potentially add further information in embodiments of the present invention with information answering questions such as: How much does parking cost at a prospective location? When is the best time to park? How much time does it take to commute from a prospective house to work? What route can be taken to work from the prospective house? The computer processor can also compare what an end user currently pays for heating costs or other costs at their house versus the prospective house. Other information such as tolls and energy costs may be received from public transportation or government run web sites. The information concerning either the existing home or a prospective home may be provided by an automated process or by a manual process entered by users. Current interest rates from banks for a first mortgage or second mortgage, and credit scores may also be provided to the computer processor.

In another embodiment of the present invention, a person's credit score gives interest rates for loans. If the person doesn't know the credit score, the embodiment of the present invention will work with a credit agency to get the score. In addition, based on a down payment that a person can make, a processor is programmed to determine what a first and second mortgage will cost to give one monthly payment for an individual to search.

In another embodiment, other factors are used, such as work location and the type of car that the individual drives.

In order to make reasonable choices in home buying that take into account all kinds of expenses associated with living in a particular home as well as quality-of-life factors, a home buyer has to have lots of information. In one or more embodiments, the present invention brings all these factors into one typically online tool for home buyers.

In one embodiment of the present invention, after entering information, such as credit scores, a processor will calculate interest rates for calculating mortgage payments based on a down payment, based at least in part on a credit score or scores. After a user/buyer has entered the location of the home the user/buyer is interested in, the processor will calculate property taxes, commuting, and other costs for all homes in the database on one single easy to read map screen. Other information may come from a census and other government sources.

In one embodiment of the present invention a processor is programmed to help the home buyer figure out his or her optimum simple total lifestyle cost, based on income and current expenses. A simple total lifestyle cost calculator, in accordance with an embodiment of the present invention, will allow the home buyer to enter a maximum monthly cost and the search tool will help find a home that fits these parameters without entering work data for commuting costs, but will include the cost of heating and cooling a home, taxes, and simple lawn care using averages in the industry and user input.

In one embodiment of the present invention, the processor will calculate the total lifestyle cost for a particular home, taking into account many costs including commuting and tolls, parking and distances.

In one embodiment of the present invention, registered users at a web site can use map-based tools to understand the locations of homes. Data on individual neighborhoods may also be offered on the web site. In one embodiment a tool may be provided which allows a user search a specific area by drawing a shape, such as a circle on a map, and to search that for homes inside of that shape.

In one embodiment of the present invention, a web site may be provided which will allow a home buyer to see data on homes sold during a certain time period, such as the past one, three, six, and/or twelve months, and in a certain neighborhood. The web site may also allow a home buyer to calculate the costs of commuting by train and the costs of taking toll roads.

The web site may help investors to calculate monthly payments for a particular property to figure out whether it can be a good investment. In at least one embodiment, the web site will find out rental rates, maintenance costs, and figure out whether there will be a positive cash flow at the end.

### BRIEF DESCRIPTION OF THE DRAWINGS

FIG. 1 shows a diagram of an image which can be displayed on a computer monitor to aid in searching for residential real estate in accordance with a prior art method;

FIG. 2 shows a diagram of an image which can be displayed on a computer monitor to provide a mortgage calculator function in accordance with another prior art method;

FIG. 3 shows a diagram of an image which can be displayed on a computer monitor to aid in searching for residential real estate in accordance with an embodiment of the present invention;

FIG. 4 shows a block diagram of an apparatus, method, and/or system in accordance with an embodiment of the present invention;

FIG. 5 shows an image of various information which can be displayed including conservative and aggressive estimates for monthly payments concerning a real property based on various inputs;

FIG. 6 shows an image of a map and various information which can be displayed on a computer monitor or display in accordance with an embodiment of the present invention;

FIG. 7. shows an image of a map and various information which can be displayed on a computer monitor or display in accordance with another embodiment of the present invention; and

FIG. 8. shows an image of a map and various information which can be displayed on a computer monitor or display in accordance with another embodiment of the present invention for investors.

### DETAILED DESCRIPTION OF THE DRAWINGS

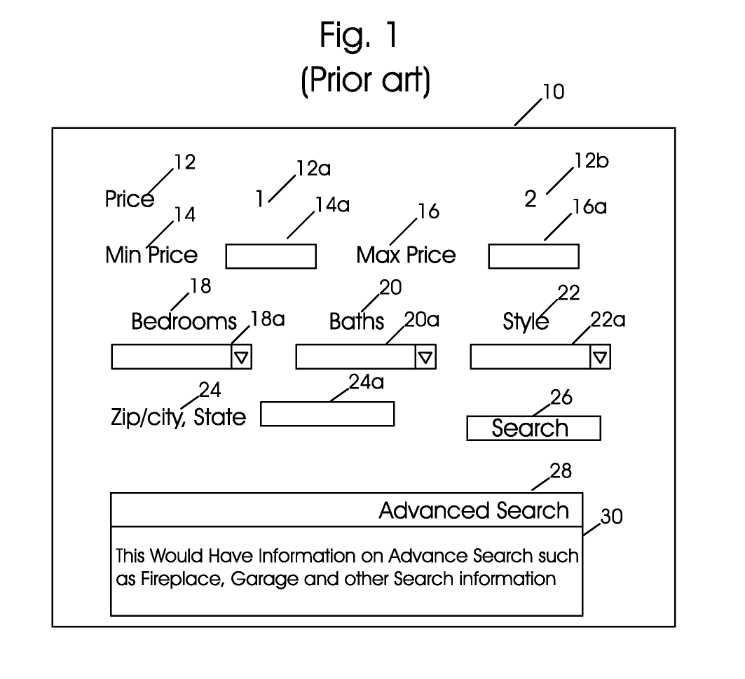

FIG. 1 shows a diagram of an image 10 which can be displayed on a computer monitor to aid in searching for residential real estate in accordance with a prior art method. The image 10 includes a designation 12 of “Price”, and designations of “1” and “2” indicating two different prices. The image 10 also includes a designation 14 of “Min Price” for minimum price and an entry field 14a for entering a minimum price for a residential property into a computer through an input device such as a computer keyboard, mouse, or screen. The image 10 also includes a designation 16 of “Max Price” for maximum price and an entry field 16a for entering a maximum price for a residential property into a computer through an input device such as a computer keyboard, mouse, or screen.

The image 10 further includes designations 18, 20, and 22 for “Bedrooms”, “Baths”, and “Style”, respectively, and entry fields 18a, 20a, and 22a, for entering number of bedrooms, number of baths, and style of residential property desired, respectively. Each of fields 18a, 20a, and 22a includes a pull down field or triangle which can be clicked on to pull down a menu of possible entries in the appropriate field.

The image 10 further includes designation 24 for “Zip/city, State” and a entry field 24a for entering a zip code, city, and state, for which a user wants to search for a residential property. A search button or field 26 is also provided which can be clicked on by a computer mouse to cause a computer search, such as an internet or data base search to be conducted for residential properties satisfying criteria set by fields 14a, 16a, 30, 20a, 22a, and 24a.

The image 10 also includes fields 28 and 30 for advanced search. The fields 28 and 30 are additional search criteria that have to do with properties such as fireplace, number of garages, and other property features but typically nothing that would effect the search towards the monthly payment.

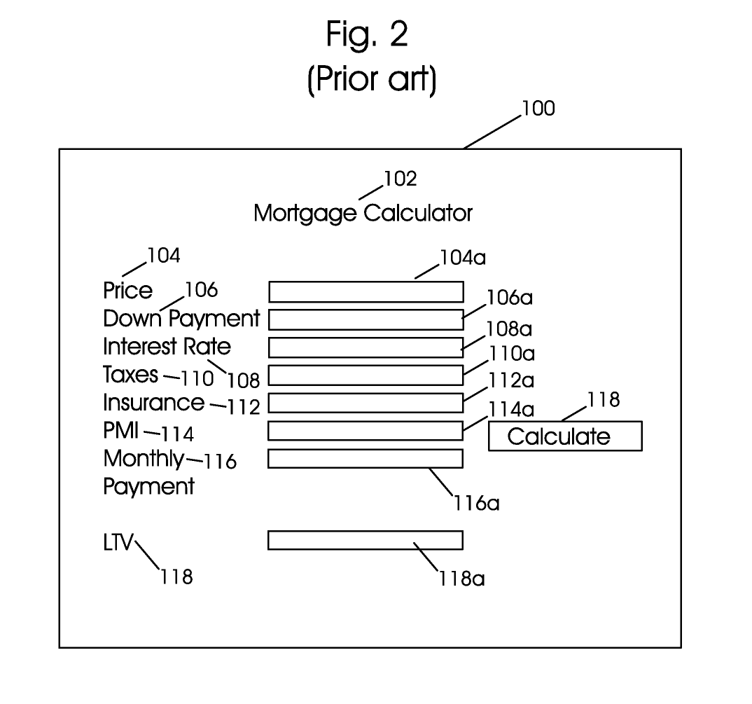

FIG. 2 shows a diagram of an image 100 which can be displayed on a computer monitor to provide a mortgage calculator function in accordance with another prior art method. The image 100 includes a title designation 102 for “Mortgage Calculator”. The image 100 includes designations 104, 106, 108, 110, 112, 114, and 116 for “Price”, “Down Payment”, “Interest Rate”, “Taxes”, “Insurance”, “PMI”, and “Monthly Payment”, respectively. Entry fields 104a, 106a, 108a, 110a, 112a, 114a, and 116a are provided next to a corresponding designation for entering the appropriate information concerning purchasing a residential real estate property. A button or field 118 can be clicked on with a computer mouse to cause a monthly mortgage payment to appear in the field 116a. The monthly mortgage payment, which appears in the field 116a is calculated by an over input, not shown. PMI (private mortgage insurance) can be calculated based on loan to value ratio shown by title designation 118 and which can be entered in field 118a. If the loan to value ratio (LTV) is 80% or more then typically there is PMI (private mortgage insurance). This can be calculated out for the individual. Also sometimes if you have a second loan called a piggy back loan, such as a home equity line of credit (HELOC) or home equity loan (HEL) then there will not be a need for PMI. Sometimes in the prior art an individual can calculate how much of a price the individual can afford to pay for a home, based on putting in some monthly payment in field 116a and then displaying the price of the home in field 104a.

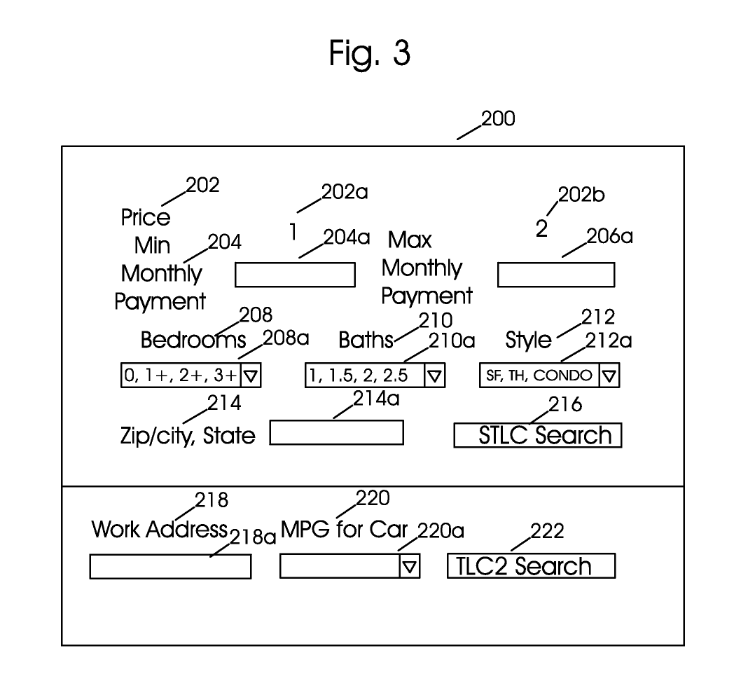

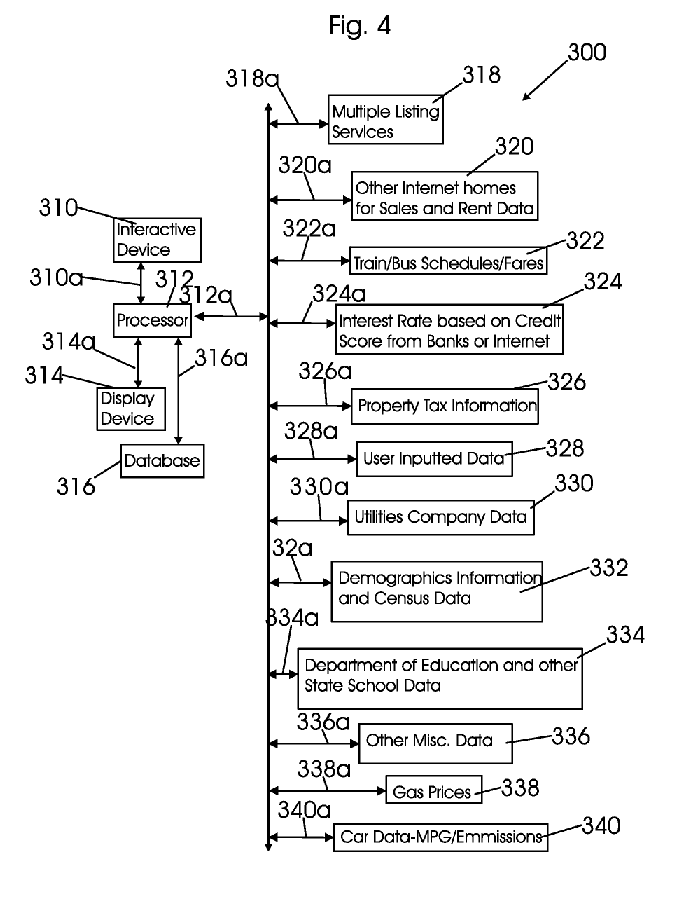

FIG. 3 shows a diagram of an image 200 which can be displayed on a computer monitor in accordance with an embodiment of the present invention to aid in searching for a residential property. The image 200 includes a designation 202 of “Price”, and designations 202a and 202b of “1” and “2” indicating two monthly payment amounts. The image 200 also includes a designation 204 of “Min Monthly Payment” and an entry field 204a for entering a minimum monthly payment for a residential property into a computer through an input device such as a computer keyboard, mouse, or screen. The image 200 also includes a designation 206 of “Max Monthly Payment” and an entry field 206a for entering a maximum monthly payment for a residential property into a computer through an input device such as a computer keyboard, mouse, or screen. A user or potentially interested home buyer would enter the minimum monthly payment and maximum monthly payment into fields 204a and 206a respectively, using a computer keyboard, mouse, or screen which may be part of an interactive device 310 shown in FIG. 4. The data entered into the interactive device 310 is supplied to the processor 312 via communications link 310a. The data may be displayed on display device 314 as an image and also stored in database 316.

The image 200 of FIG. 3 further includes designations 208, 210, and 212 for “Bedrooms”, “Baths”, and “Style”, respectively, and entry fields 208a, 210a, and 212a, for entering number of bedrooms, number of baths, and style of residential property desired, respectively. Each of fields 208a, 210a, and 212a includes a pull down field or triangle which can be clicked on to pull down a menu of possible entries in the appropriate field.

The image 200 further includes designation 214 for “Zip/city, State” and a entry field 214a for entering a zip code, city, and state, for which a user wants to search for a residential property. This could also have a mini map which can draw a figure or shape such as a square or circle or polygon on the map to search. A search button or field 216 designated “STLC Search” (standard total lifestyle cost which is based on principal payment+current interest rates and type of mortgage+taxes+insurance=total monthly payment+potentially additional costs). In another aspect of at least one embodiment of the present invention the standard total lifestyle cost could also include heating and cooling costs, such as gas and electric costs, based on user preferences like how many people are in the house, and whether there are kids in the home. The STLC Search button or field 216 can be clicked on by a computer mouse to cause a computer search, such as an internet or data base search to be conducted for residential properties satisfying criteria set by fields 204a, 206a, 208a, 210a, 212a, and 214a. The search may be conducted by processor 312 via communications link 312a, which may be connected to the internet.

The image 200 also includes designations 218 and 220 and corresponding entry fields 218a and 220a, which refer to “Work Address” and “MPG for Car”, respectively. An individual can use an input device such as a computer keyboard, mouse, or screen, to enter a work address and the miles per gallon that the individual's car gets into fields 218a and 220a, respectively. The data entered into fields 218a and 220a may be input through interactive device 310 into processor 312, and then may be stored in database 316 and displayed on display device 314 of FIG. 4. The individual can then click on the button 222, shown in FIG. 3, to do a residential real estate internet or data base search based on the work address and miles per gallon entered, and/or also based on the criteria set by a combination of fields 204a, 206a, 208a, 210a, 212a, 214a, 218a, and 220a.

FIG. 4 shows a block diagram 300 of an apparatus, method, and/or system in accordance with an embodiment of the present invention.

The block diagram 300 shows the interactive device 310, the processor 312, the display device 314, the database 316, multiple listing services 318, other internet homes for sales and rent data 320, train/bus schedules/fares 322, interest rate based on credit score from banks or internet 324, property tax information 326, user inputted data 328, utilities company data 330, demographics information and census data 332, department of education and other state school data 334, other miscellaneous data 336, gas prices 338, and car data—miles per gallon emissions 340. Each of the components 318-40 may be a computer or computer processor which has and/or supplies the information identified to the processor 312. For example, the multiple listing services 318 may be a computer which has and/or supplies information regarding multiple listing services.

The components 310, 314, and 316 may be electrically connected to and/or communicate with processor 312 via communications links 310a, 314a, and 316a respectively. The components 318, 320, 322, 324, 326, 328, 330, 332, 334, 336, 338, and 340 may communicate with the processor 312 via communications links 318a, 320a, 322a, 324a, 326a, 328a, 330a, 332a, 334a, 336a, 338a, and 340a, respectively, and communications links 312a and 312b.

The interactive device 310 can be, for example, a computer keyboard, a computer mouse, and/or a computer monitor. A user can input information into the interactive device 310 such as the user's current work address, the car make and model owned by the user, the type of home the user is looking for, and the user's credit score. Information concerning the type of home that the user is looking for may include information concerning the number of baths and the number of beds, and other home information. The processor 312 may include its own computer memory. The processor 312 may be programmed to search the database 316 for a home based on how much the individual wants their monthly payment to be within a certain range. The user can also enter other lifestyle factors such as distance or time from a place such as school, work, family, skiing, airport, or other places.

The display device 314 may display search results which can be sorted by any factor that a user selects. The search results may be first sorted based on monthly payment. The data may be shown on a map based system or a grid system. Users can add favorites and add notes for each home.

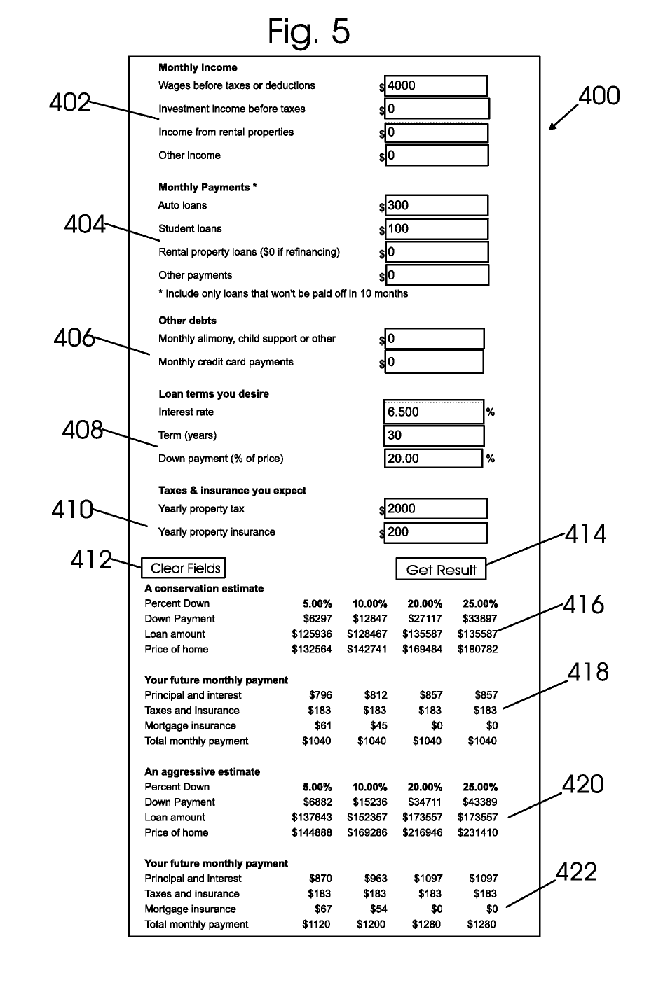

FIG. 5 shows an image or screen 400 of various information which can be entered and/or displayed on a computer monitor or display device such as display device 314 shown in FIG. 4. The image or screen 400 includes fields 402, 404, 408, 410, 416, 418, 420, and 422, and entry buttons 412 and 414.

Field 402 shows information concerning monthly income for a user. The monthly income data may include categories for “wages before taxes or deductions”, “investment income before taxes”, “income from rental properties”, and “other income”. To the right of the categories for monthly income are boxes or entry fields into which data can be entered by a user into an interactive device, such as 310 in FIG. 4. For example, “4000”, for four thousand dollars, is shown entered in the box to the right of “wages before taxes or deductions”.

Field 404 shows information concerning monthly payments for a user. The monthly payments data may include categories for “auto loans”, “student loans”, “rental property loans ($0 if refinancing), “other payments”. The monthly payments data in field 404 may include only loans that won't be paid off in ten months. To the right of the categories for monthly payments are boxes or entry fields into which data can be entered by a user into an interactive device, such as 310 in FIG. 4. For example, “300”, for three hundred dollars, is shown entered in the box to the right of “auto loans”, and “100”, for one hundred dollars is shown entered in the box to the right of “student loans”.

Field 406 shows information concerning other debts for a user. The other debts data may include categories for “monthly alimony”, and “monthly credit card payments”. To the right of the categories for other debts are boxes or entry fields into which data can be entered by a user into an interactive device, such as 310 in FIG. 4.

Field 408 shows information concerning loan terms that a user desires. The loan terms that a user desires may include categories for “interest rate”, “term (years)”, and “down payment (% of price). To the right of the categories are boxes or entry fields into which data can be entered by a user into an interactive device, such as 310 in FIG. 4. For example, “6.500” for 6.5%, “30” for 30 years and “20.00” for 20% are shown for the down payment (% of price).

Field 410 shows information concerning taxes and insurance that a user expects. The taxes and insurance that a user expects may include categories for “yearly property tax”, and “yearly property insurance”. To the right of the categories are boxes or entry fields into which data can be entered by a user into an interactive device, such as 310 in FIG. 4. For example, “2000” for $2,000.00 yearly property tax, and $200.00 for yearly property insurance.

Field or button 412 when clicked on using a computer mouse, allows a user to go back to clear all the input fields on. Field or button 414 when clicked on using a computer mouse, allows a user to get results below for fields 416, 418, 420, and 422 from the above inputs.

Field 416 shows information concerning a conservative estimate which is based on what the user entered above. This information shows the home price range that a person can afford based on lower loan amounts and lower interest rates. Field 418 shows what those payments would be like. The conservative estimate in this case shows how much down payment is required to have a certain percent down payment for a home of a certain price using a conservative estimate.

Field 418 shows information concerning the future monthly payment for a user for a particular real property using the conservative estimate data of field 416. The field 418 shows principal and interest, taxes and insurance, mortgage insurance, and total monthly payment for a particular percent down payment.

Field 420 shows an aggressive estimate which is based on higher interest rates and based on what a user has entered above. The aggressive estimate in this case shows how much of a down payment is required to have a certain percent down payment for a home of a certain price using an agressive estimate.

Field 422 shows information concerning the future monthly payment for a user for a particular real property using the aggressive estimate data of field 420. The field 422 shows principal and interest, taxes and insurance, mortgage insurance, and total monthly payment for a particular percent down payment.

The above information can be used to give an approximation of what a user's monthly payment will be per month. If a user puts person and current information as shown in tables above, the system will then calculate a more accurate monthly payment based on the user's information.

Tables A-S shown below relate to expenses concerning a certain home for possible purchase and/or rental but these concepts are applied typically to all properties in the system. Some of the information is provided by registered users for actual data and some of the information is derived from looking at similar homes in the same area to project costs. These costs may include gas, electric, cable and so on. There may also be individual inputs like loans and other non discretionary and discretionary spending for each person.

Table A shows projected and actual housing expenses, and the difference between projected and actual housing expenses for a potential residential property. The projected costs can be derived from computer software. The mortgage payment is typically a factor of the current price of the home, or a price that a user is willing to pay. The current type of loan may be selected by a user, along with the down payment, interest rate, and insurance or PMI. These calculations may typically be done by the processor 312, shown in FIG. 4, for all the houses and shown on a map.

TABLE A

| HOUSING | Projected Cost | Actual Cost | Difference |
|---|---|---|---|
| Mortgage or rent | $3,670 | $3,670 | $0 |
| Phone | $65 | $65 | $0 |
| Electricity | $150 | $150 | $0 |
| Gas | $150 | $150 | $0 |
| Water and sewer | $40 | $40 | $0 |
| Cable | $116 | $116 | $0 |
| Waste removal | $10 | $10 | $0 |
| Maintenance or repairs | $200 | $0 | $200 |
| Internet | $150 | $150 | $0 |
| Other | $0 | $0 | $0 |
| Subtotals | $4,551 | $4,321 | $230 |

Table B shows projected, actual, and the difference between projected and actual entertainment expenses for a particular family or individual that will potentially be buying a residential property. The table B data may be entered by a user only once when registering into a system run on processor 312 for searching such as searches using image 102 shown in FIG. 3.

TABLE B

| Entertainment | Projected Cost | Actual Cost | Difference |
|---|---|---|---|
| Video/DVD | | | $0 |
| CDs | | | $0 |
| Movies | | | $0 |
| Concerts | | | $0 |
| Sporting events | | | $0 |
| Live theater | | | $0 |
| Other | | | $0 |
| Other | | | $0 |
| Other | | | $0 |
| Subtotals | $0 | $0 | $0 |

Table C shows projected, actual, and the difference between projected and actual loan expenses for a particular family or individual that will potentially be buying a residential property. The Table C data may be entered by a user only once when registering into a system, such as a system run on processor 312 for searches such as searches using image 102 of FIG. 3.

TABLE C

| LOANS | Projected Cost | Actual Cost | Difference |
|---|---|---|---|
| Personal | $0 | $0 | $0 |
| Student | | | $0 |
| Credit card | | | $0 |
| Credit card | | | $0 |
| Credit card | | | $0 |
| Other | | | $0 |
| Subtotals | $0 | $0 | $0 |

Table D shows projected, actual, and the difference between projected and actual taxes for a particular family or individual that will potentially be buying a residential property. The table D data may be derived by the processor 312 of FIG. 4, from the current public records via the internet or entered by user via interactive device 310. This typically will be calculated for each property.

TABLE D

| TAXES | Projected Cost | Actual Cost | Difference |
|---|---|---|---|
| Federal | | | $0 |
| State | | | $0 |
| Local | | | $0 |
| Other | | | $0 |
| Subtotals | $0 | $0 | $0 |

Table E shows projected, actual, and the difference between projected and actual savings or investments for a particular family or individual that will potentially be buying a residential property. In one embodiment, this is entered by a user, such as through interactive device 310 only once when registering into the system, such as a system running on processor 312.

TABLE E

| SAVINGS OR | | | |
|---|---|---|---|
| INVESTMENT | Projected Cost | Actual Cost | Difference |
| Retirement account | $200.00 | $200.00 | $0 |
| Investment account | | | $0 |
| Other | | | $0 |
| Subtotals | $200.00 | $200.00 | $0 |

Table F shows projected, actual, and the difference between projected and actual charity expenses for a particular family or individual that will potentially be buying a residential property. In one embodiment of the present invention, the Table F data may be entered by a user only once when registering into the system, such as a system running on processor 312.

TABLE F

| GIFTS AND DONATIONS | Projected Cost | Actual Cost | Difference |
|---|---|---|---|
| Charity 1 | | | $0 |
| Charity 2 | | | $0 |
| Charity 3 | | | $0 |
| Subtotals | $0 | $0 | $0 |

Table G shows projected, actual, and the difference between projected and actual legal expenses for a particular family or individual that will potentially be buying a residential property.

TABLE G

| LEGAL | Projected Cost | Actual Cost | Difference |
|---|---|---|---|
| Attorney | | | $0 |
| Alimony | | | $0 |
| Payments on lien | | | $0 |
| or judgment | | | |
| Other | | | $0 |
| Subtotals | $0 | $0 | $0 |

Table H shows projected, actual, and the difference between projected and transportation expenses for a particular family or individual that will potentially be buying a residential property. The Table H data, in at least one embodiment, is entered, by a user, typically into interactive device 310, only once when registering into the system. The data may be entered through an interactive device 310 such as a computer mouse or keyboard and/or by use of an image, such as image 102 on a computer monitor or display device 314.

TABLE H

| TRANSPORTATION | Projected Cost | Actual Cost | Difference |
|---|---|---|---|
| Vehicle payment | $472.00 | $472.00 | $0 |
| Bus/taxi fare | $0 | $0 | $0 |
| Insurance | $125.00 | $125.00 | $0 |
| Licensing | $0 | $0 | $0 |
| Fuel | $350 | $400 | ($50) |
| Maintenance | $0 | $0 | $0 |
| Tolls Per Month | $216.00 | $200.00 | $16 |
| Subtotals | $1163.00 | $1,197.00 | ($34.00) |

Table I shows projected, actual, and the difference between projected and insurance expenses for a particular family or individual that will potentially be buying a residential property. The Table I data is typically entered only once when registering into the system which may be a computer software system or process running on the processor 312. A user may register into the system via interactive device 310 via an interface or image, similar to image 200 shown in FIG. 3. Some of the Table I data can be derived from the internet by processor 312 or through sources, such as sources 318-340. The data may be entered through an interactive device 310 such as a computer mouse or keyboard and/or by use of an image, such as image 102 on a computer monitor or display device 314.

TABLE I

| INSURANCE | Projected Cost | Actual Cost | Difference |
|---|---|---|---|
| Home | | | $0 |
| Health | | | $0 |
| Life | | | $0 |
| Other | | | $0 |
| Subtotals | $0 | $0 | $0 |

Table J shows projected, actual, and the difference between projected and food expenses for a particular family or individual that will potentially be buying a residential property. The table J data may be entered only once when registering into a computer software system, such as a system running on processor 312 shown in FIG. 4.

TABLE J

| FOOD | Projected Cost | Actual Cost | Difference |
|---|---|---|---|
| Groceries | $200.00 | $200.00 | $0 |
| Dining Out | $300.00 | $300.00 | $0 |
| Other | $200.00 | $100.00 | $100.00 |
| Subtotals | $700.00 | $600.00 | $100.00 |

Table K shows projected, actual, and the difference between projected and pet expenses for a particular family or individual that will potentially be buying a residential property. The table K data may be entered only once when registering into a system, such as a computer software system or process running on processor 312 shown in FIG. 4.

TABLE K

| PETS | Projected Cost | Actual Cost | Difference |
|---|---|---|---|
| Food | | | $0 |
| Medical | | | $0 |
| Grooming | | | $0 |
| Toys | | | $0 |
| Other | | | $0 |
| Subtotals | $0 | $0 | $0 |

Table L shows projected, actual, and the difference between projected and personal care expenses for a particular family or individual that will potentially be buying a residential property. The table L data may be entered via interactive device 310, only once when registering into a system, such as a computer software process or system running on processor 312 of FIG. 4.

TABLE L

| PERSONAL CARE | Projected Cost | Actual Cost | Difference |
|---|---|---|---|
| Medical | | | $0 |
| Hair/Nails | | | $0 |
| Clothing | | | $0 |
| Dry Cleaning | | | $0 |
| Health Club | | | $0 |
| Organization Dues or Fees | | | $0 |
| Other | | | $0 |
| Subtotals | $0 | $0 | $0 |

Table M shows expenses regarding home sale price etc.

TABLE M

| | Projected Cost | Rate | Monthly |
|---|---|---|---|
| Home Sale Price | $519,000 | | $0 |
| Down Payment | 0 | | $0 |
| First Mortgage | $415,200.00 | 5.25% | $2,289.00 |
| Second Mortgage | $103,800.00 | 6.25% | $681 |
| Property Insurance | $400.00 | | $33.33 |
| Taxes | $8000.00 | | $666.67 |
| Total | | | $3,670 |
| Cost Per Sqft | $2450 | $4,235.78 | $1.7289 |

Table N shows expenses regarding projected monthly income for the person or family potentially purchasing the particular residential real estate property.

TABLE N

| | | |
|---|---|---|
| Projected Monthly Income | Income 1 | $4,000.00 |
| | Extra Income | $4,000.00 |
| | Total monthly income | $8,000.00 |

Table O shows expenses regarding actual monthly income for the person or family potentially purchasing the particular residential real estate property.

TABLE O

| | | |
|---|---|---|
| Actual Monthly Income | Income 1 | $4,000.00 |
| | Extra Income | $4,000.00 |
| | Total monthly income | $8,000.00 |

Table P shows a sample of projected income from table N minus total expenses for a particular family or individual. The projected monthly balance may come from user inputs, while the actual monthly balance may come from actual data.

TABLE P

| | |
|---|---|
| PROJECTED Monthly BALANCE | $1,386.00 |
| (Projected income minus expenses) | |
| ACTUAL Monthly BALANCE | $1,682.00 |
| (Actual Income minus expenses) | |
| Monthly DIFFERENCE | $296.00 |
| (Actual income minus projected income) | |

Table Q shows the tax savings, tax bracket, taxes paid and interest, effective mortgage, total savings, and extra for home business for the particular individual or family for the residential real estate property potentially being purchased. The Information shown in table Q may be called an effective mortgage meaning what are an individual's payment is after the individual gets a refund based on the individual's tax bracket which is typically based on AGI (Adjusted Gross Income)

TABLE Q

| Tax Saving | $ |
|---|---|
| Tax Bracket | 38.50% |
| Taxes Paid + Interest | $36,511.784 |
| Tax Saving | 14057.03684 |
| Effective Mortgage | $2,498.56 |
| Total Saving | $30,691.71 |
| Extra for Home Business | $6,380.22 |
| | $37,071.93 |

Table R shows samples of total projected cost, total actual cost, and the difference between the total projected cost and total actual cost for the particular residential real estate property.

TABLE R

| | |
|---|---|
| Total Projected Cost | $6,614.00 |
| Total Actual Cost | $6,318.00 |
| Total Difference | $296.00 |

Table S shows information regarding cost of car travel for the individual or family for the particular residential real estate property or home being considered for purchase. The user will typically input what type of car the user has and the MPG (miles per gallon) will be determined by the system. The tolls and gas are computed for each property for each user input for work or other locations. If there are more than one commuter the processor 312 will calculate one or more users commuting costs to work.

TABLE S

| | | | |
|---|---|---|---|
| Miles Driven Per Day Car 1 | 120 | GasPrice | $2.15 |
| MPGCar1 | 25 | $0 | $309.60 |
| Tolls Car1 | $3.85 | | $177.10 |
| Miles Driven Per Day Car 2 | 20 | GasPrice | $2.00 |
| MPG Car2 | 30 | | $40.00 |
| Tolls Car2 | $0.85 | | $39.10 |

The data shown in tables A-S above may be entered through an input device, such as through interactive 310 shown in FIG. 4, and may be stored in processor 312 or in database 316. The data shown in tables A-S may be displayed on a computer monitor or display device such as display device 314 shown in FIG. 4.

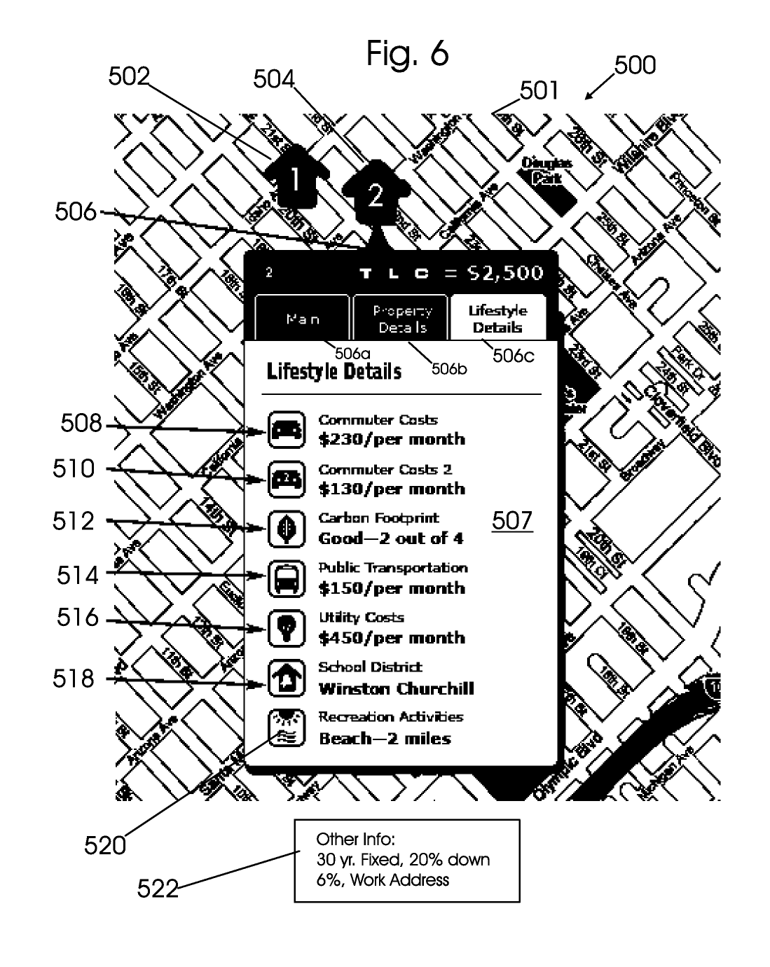

FIG. 6 shows an image or screen 500 of various information which can be entered and/or displayed on a computer monitor or display device such as display device 314 shown in FIG. 4. The image or screen 500 includes an image of a map 501, including depictions of a plurality of streets, such as “Washington Ave.”. The image or screen 500 also includes fields 502, 504, 506, 508, 510, 512, 514, 516, 518, 520, and 522.

The field 502 shows a house icon with a “1” inside, indicating that a house or a particular real property is for sale at the location on the map 501 where the house icon “1” is located. Similarly, the field 504 shows a house icon “2” corresponding to another house or another real property. Field 506 shows a box of information referring to the house corresponding to house icon “2”.

The Field or box 506 shows TLC=$2500.00. “TLC” means “total living cost”, which is the total monthly living cost for the house corresponding to house icon “2”. The Field 506 has buttons 506a for “Main” which gives information such as the address, bedrooms, baths, pictures of the house or property, 506b for “Property Details”, and 506c for “Lifestyle Details”. When a user clicks on the button 506c for “Lifestyle Details” using a computer mouse, the Lifestyle Details menu, box, or table 507 shown in FIG. 6, appears on the computer monitor or display device, such as display device 314.

The lifestyle details menu 507 includes fields 508, 510, 512, 514, 516, 518, and 520. Field 508 has an icon for and information regarding commuter costs from the real property “2” to the user's place of business. This is based on the type of the car the particular user drives for MPG (miles per Gallon), how many miles to work, tolls and current gas cost. Field 510 has an icon for information regarding commuter costs 2 which could be based on another user who is going to be living in the house and commuting to another location from the real property “2” to the other user's place of business. Alternatively, the second commuter cost shows if a user drives a different car what the cost of commuting would be. The second commuting cost could also be be the cost of commuting using public transportation or to public transportation, such as train stations. Field 512 has an icon for and information regarding a carbon footprint for real property “2” if a user drives their car to work each day This is the user's total carbon output based on user information about the type of car they drive and how many miles they drive to work. Field 514 has an icon for and information regarding public transportation costs from the real property “2” to the user's place of business. The field 514 information is based on taking public transportation to work such as a bus or train versus driving a car to work. Field 516 has an icon for and information regarding utility costs for the real property “2”. The utility costs in field 516 may include but may not be limited to gas, electric, water, and sewer , and other utility costs. Field 518 has an icon for and information regarding the particular school district in which the real property “2” is located. Field 520 shows an icon for and information concerning available recreation activities close to the real property “2”. In this case the beach is located within 2 miles of real property “2”.

Field 522 shows other miscellaneous information such as the number of years for a mortgage, down payment needed, interest rate for mortgage, and work address for the user.

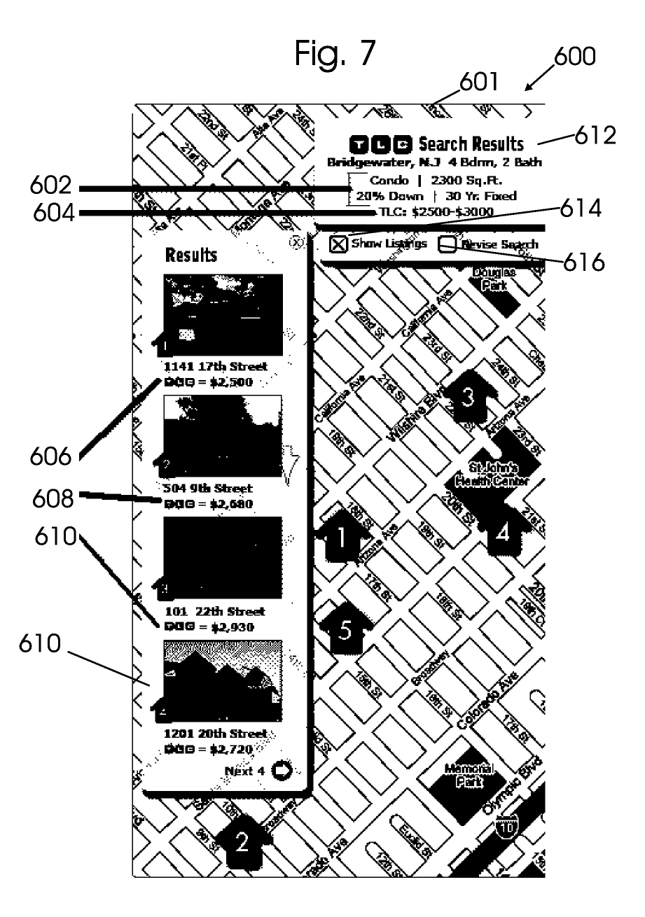

FIG. 7 shows an image or screen 600 of various information which can be entered and/or displayed on a computer monitor or display device such as display device 314 shown in FIG. 4. The image or screen 600 includes an image of a map 601, including depictions of a plurality of streets, and real property icons, such as real property icons “1”, “2”, “3”, “4”, and “5”, which identify the locations of real properties for sale. The image or screen 600 also includes fields 602, 604, 606, 608, 610, 612, 614, and 616.

Field 612 shows that the “TLC” or total living costs search results are for a real property or home in Bridgewater, N. J., having four bedrooms, two bathrooms. Field 602 indicates that the search refers to a condominium, having about 2,300 square feet, with a 20% down payment and a thirty year fixed mortgage required. Field 604 indicates that the search is for total living cost between $2500 and $3,000.00.

Field 614 shows a box with a “x” next to show listings, to indicate that the user has indicated that the real properties or listings satisifying the criteria in fields 612, 602, and 604, should be shown. Field 616 allows a user to revise the search by entering an “x” in the box next to revise search.

Fields 606, 608, 610, and 611 show information regarding four real properties which are for sale which satisfy the criteria set out in fields 612, 602, and 604. Each of the fields 606, 608, 610, and 611 may include a picture of the particular real property, which may be in color, an address for the real property, and a total living cost for the real property. In accordance with an embodiment of the present invention, this allows a user to look at all homes at once, which is different from the prior art.

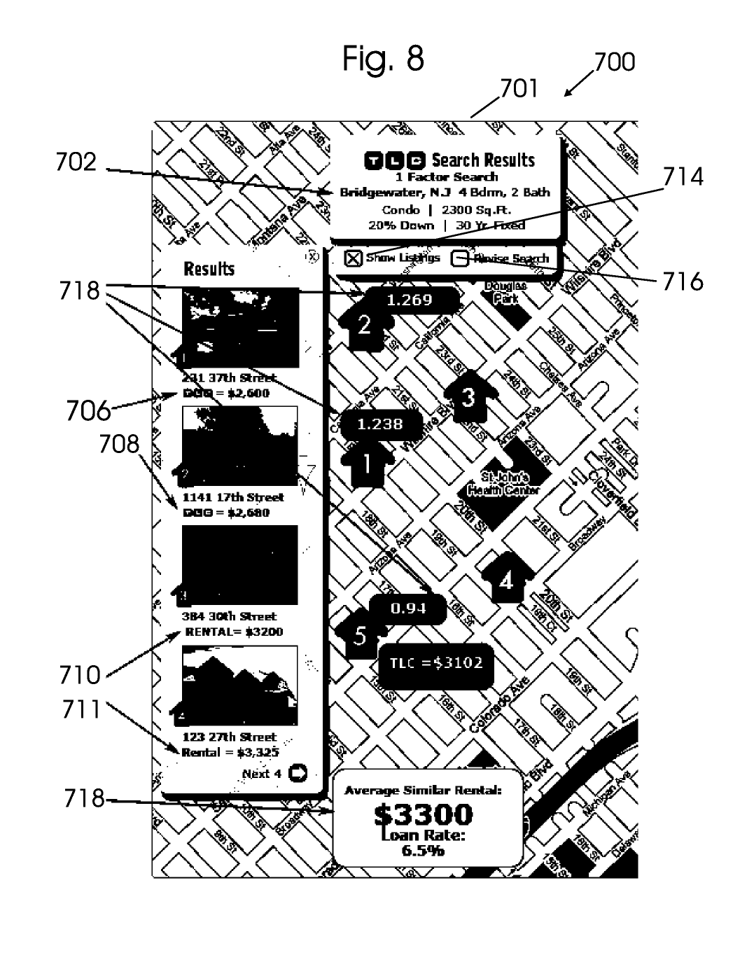

FIG. 8 shows an image or screen 700 of various information which can be entered and/or displayed on a computer monitor or display device such as display device 314 shown in FIG. 4. This information is typically for investors. The image or screen 700 includes an image of a map 701, including depictions of a plurality of streets, and real property icons, such as real property icons “1”, “2”, “3”, “4”, and “5”, which identify the locations of real properties for sale. The image or screen 700 also includes fields 702, 706, 708, 710, 711, 714, 716, and 718.

Field 702 shows that the “TLC” or total living costs search results are for a real property or home in Bridgewater, N. J., having four bedrooms, two bathrooms. Field 702 also indicates that the home or real property being searched for will be a condominium, having about 2,300 square feet, with a 20% down payment and a thirty year fixed mortgage required.

Field 714 shows a box with a “x” next to show listings, to indicate that the user has indicated that the real properties or listings satisifying the criteria in fields 702 should be shown. Field 716 allows a user to revise the search by entering an “x” in the box next to revise search.

Fields 706 and 708 show information regarding two real properties which are for sale which satisfy the criteria set out in fields 702. Each of the fields 706 and 708 may include a picture of the particular real property, which may be in color, an address for the real property, and a total living cost for the real property.

Fields 710 and 711 show show information regarding two real properties which are being offered for rent and which satisfy the type of real property specified in field 702, i.e. a condo having four bedrooms, two bathrooms, and about 2300 square feet. Each of the fields 710 and 711 may include a picture of the particular real property, which may be in color, an address for the real property, and the rental cost for the property. Field 718 may show a ratio of what average similar rental for the type of real property specified in field 702 divided by the TLC of that home based on the criteria of user. Field 718 shows that if you have results greater than 1 then you will have positive cash flow for the property and that the subject properties, such as one or both of properties 1 and 2 would be a good investment. The TLC for property 1 is 2600 and the Average price of rental is 3300. The ratio of 3300/2600 gives 1.269. However, if the ratio of average price of rental over TLC for property is below 1 such as for property 5 which has a TLC of $3502 and an Average of $3300, and therefore a ratio of 0.94, then the property is a bad investment. This is a new novel way to invest since you can look at all the homes at once.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method comprising
entering a user monthly affordable amount for a user into an interactive device;
searching on the internet through information concerning a plurality of required monthly cost amounts for a corresponding plurality of real properties;
displaying information concerning one or more real properties of the plurality of real properties; and
wherein each of the one or more real properties have a corresponding required monthly cost amount which is less than or approximately equal to the user monthly affordable amount.

2. The method of claim 1 wherein
each of the plurality required monthly cost amounts include an amount for property tax for a corresponding real property.

3. The method of claim 1 wherein
each of the plurality of required monthly cost amounts include a commuting cost for the user from a location of a corresponding real property to a user work location.

4. The method of claim 3 wherein
the commuting cost is based on the type of car used by a user and a current price of gasoline.

5. The method of claim 3 wherein
the commuting cost includes a cost of public transportation.

6. The method of claim 3 wherein
the commuting cost includes parking costs.

7. The method of claim 3 wherein
each of the plurality of required monthly cost amounts includes heating and cooling costs for the corresponding real property.

8. The method of claim 3 wherein
each of the plurality of required monthly cost amounts includes landscaping maintenance costs for the corresponding real property.

9. The method of claim 3 wherein
each of the plurality of required monthly cost amounts includes garbage collection costs for the corresponding real property.

10. The method of claim 3 wherein
each of the plurality of required monthly cost amounts includes first mortgage costs for the corresponding real property.

11. The method of claim 3 wherein
each of the plurality of required monthly cost amounts includes second mortgage costs for the corresponding real property.

12. The method of claim 3 wherein
the commuting cost includes a cost for tolls.

13. The method of claim 3 wherein
the commuting cost includes a cost for road charges.

14. A method comprising
entering a user monthly affordable amount for a user into an interactive device;
searching on the internet through information concerning a plurality of required monthly cost amounts for a corresponding plurality of real properties;
displaying information concerning one or more real properties of the plurality of real properties; and
wherein each of the one or more real properties have a corresponding required monthly cost amount which is less than or approximately equal to the user monthly affordable amount
wherein each of the one or more real properties show a ratio of costs per month similar rentals to the monthly cost of the properties.

15. A method comprising
determining a total living cost for a real property;
determining an average monthly rental price for the real property;
dividing the average monthly rental price for the real property by the total living cost for the real property to determine a ratio; and
advising a user that it would be favorable to purchase the real property if the ratio is greater than one, and unfavorable to purchase the real property if the ratio is less than one.
